(19) United States
(12) Patent Application Publication
(10) Pub. No.: US 2005/0128313 A1
(43) Pub. Date: Jun. 16, 2005

(54) Photographing apparatus having a liquid-crystal display

(75) Inventor: Koji Kobayashi, Saitama (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/001,062

(22) Filed: Dec. 2, 2004

(30) Foreign Application Priority Data
Dec. 4, 2003 (JP) 2003-405977

(51) Int. Cl. H04N 5/222; G02F 1/1335

(52) U.S. Cl. 348/222.1; 348/333.01

(57) ABSTRACT

Image data is produced on the basis of an image signal outputted from a CCD image sensor. The produced image data is temporarily stored in a SDRAM. A CPU detects a color temperature of outside light on the basis of color-temperature information outputted from a color-temperature sensor. A DSP adjusts values of R and B of the image data, which includes the values of R, G and B, on the basis of the detected color temperature of the outside light. The image data having the adjusted values of R and B is inputted into a liquid-crystal panel, which is illuminated by the outside light supplied from a light guide plate to display an image thereon.

### BACKGROUND OF THE INVENTION

1. Field of the Invention

The present invention relates to a photographing apparatus, and in particular to a photographing apparatus having a liquid-crystal display in which a transmission liquid-crystal panel is illuminated by using outside light besides backlight.

2. Description of the Related Art

At present, photographing apparatuses of a digital camera and so forth are widely used. Almost all of the photographing apparatuses are provided with a liquid-crystal display for displaying an image, and some of them have a telephone function. The liquid-crystal display comprises a liquid-crystal panel. By utilizing the liquid-crystal panel, it is possible to instantaneously confirm a subject before photographing. Further, it is also possible to promptly confirm a taken image. Thus, convenience of the photographing apparatus is improved. In addition, the liquid-crystal panel is suited for elongating an operating time of the photographing apparatus and for downsizing the photographing apparatus, since power consumption of the liquid-crystal panel is small and a shape thereof is thin.

The liquid-crystal display comprises the liquid-crystal panel into which an image is inputted, a light guide plate for guiding illumination light to the liquid-crystal panel, and a light source for supplying the light to the light guide plate. In general, is used a backlight system in which the liquid-crystal panel is illuminated by the light radiated from the light source. However, when the liquid-crystal panel is illuminated in this way, electric power for activating the light source is necessary. Thus, in a case that the photographing apparatus merely has an exclusive power source, an operating time thereof is liable to be shortened. In view of this, a liquid-crystal display recently put to practical use utilizes outside light of sunlight and so forth as the illumination light of the liquid-crystal panel. Japanese Patent Laid-Open Publication No. 2000-115600 discloses a liquid-crystal display device which is capable of introducing more outside light and is provided with a lid attached to an outside-light introducing portion in order to effectively use the backlight.

However, when the photographing apparatus uses the backlight and the outside light as the illumination light of the liquid-crystal panel, a color to be reproduced on the liquid-crystal panel becomes different due to a color temperature of the outside light. For example, in a case that the vespertine sunlight is utilized as the outside light, an image inputted into the liquid-crystal panel has a strong red tinge since the sunlight has a low color temperature and is reddish. Meanwhile, in a case that the blueish outside light having a high color temperature is utilized as the illumination light, an image of the liquid-crystal panel is also blueish. Thus, when image data obtained by photographing is inputted into the liquid-crystal panel illuminated by the reddish outside light and so forth, a user sometimes mistakenly recognizes the image color.

### SUMMARY OF THE INVENTION

In view of the foregoing, it is a primary object of the present invention to provide a photographing apparatus in which power consumption is reduced and an image having true tonality is reproduced on a liquid-crystal panel even when an outside light is used as an illumination light of the liquid-crystal panel.

In order to achieve the above and other objects, the photographing apparatus according to the present invention comprises a liquid-crystal panel, an illumination-mode setting member, a color-temperature detector, and a color-balance corrector. The liquid-crystal panel is illuminated by either of backlight and outside light. The illumination-mode setting member sets one of a first illumination mode for illuminating the liquid-crystal panel with the backlight, and a second illumination mode for illuminating the liquid-crystal panel with the outside light. The color-temperature detector detects a color temperature of the outside light. When the second mode is set, the color-balance corrector corrects color balance of image data in accordance with the color temperature of the outside light detected by the color-temperature detector. The corrected image data is inputted into the liquid-crystal panel.

In a preferred embodiment, the photographing apparatus is a digital camera in which the image data is produced on the basis of an image signal outputted from a CCD image sensor. The color-temperature detector detects the color temperature of the outside light on the basis of the image signal sent from the CCD image sensor. Alternatively, the color-temperature detector detects the color temperature of the outside light on the basis of color-temperature information sent from a color-temperature sensor disposed at a position where the outside light enters.

It is preferable that a rear side of the liquid-crystal panel is provided with a light guide plate for illuminating the liquid-crystal panel from the rear side. The outside light is introduced from a light introducing portion formed at one end of the light guide plate. The color-temperature sensor is disposed near the light introducing portion.

Meanwhile, when the first illumination mode is set, the color-balance corrector does not correct the image data.

According to the photographing apparatus of the present invention, the backlight is turned on to illuminate the liquid-crystal panel when the outside light is weak, and the outside light is utilized to display the image on the liquid-crystal panel when the outside light is intense. Thus, electric power consumption may be reduced. Further, the image having correct tonality is reproduced on the liquid-crystal panel also when the outside light is utilized as the illumination light.

### BRIEF DESCRIPTION OF THE DRAWINGS

The above objects and advantages of the present invention will become apparent from the following detailed description of the preferred embodiments of the invention when read in conjunction with the accompanying drawings, in which:

FIGS. 1A and 1B are perspective views respectively showing a front side and a rear side of a digital camera according to the present invention;

FIG. 2 is a block diagram of the digital camera shown in FIGS. 1A and 1B;

FIG. 3 is a schematic section view of a liquid-crystal display vertically cut along a plane perpendicular to a liquid-crystal panel;

FIG. 4 is a plan view of a liquid-crystal screen on which a menu is displayed;

FIG. 5 is a partial block diagram explaining a correction operation of image data;

FIG. 6 is a flowchart showing an operation of the digital camera;

FIG. 7 is a flowchart showing an operation executed when color-difference data is changed on the basis of a color temperature of an outside light to display an image on the liquid-crystal panel;

FIG. 8 is a block diagram showing a second embodiment of the digital camera in which a color temperature of the outside light is detected by using a CCD image sensor; and

FIG. 9 is a partial block diagram explaining a correction operation of image data executed in the digital camera of the second embodiment.

### DETAILED DESCRIPTION OF THE PREFERRED EMBODIMENT(S)

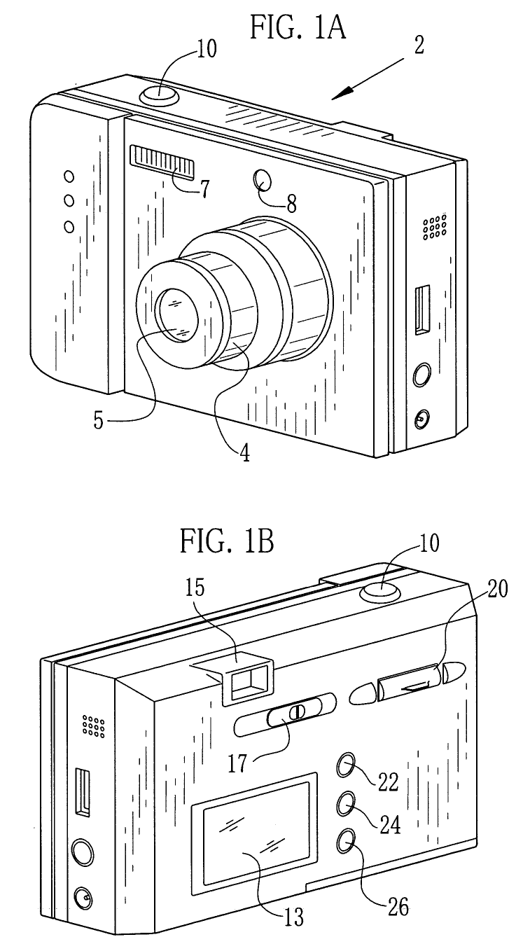

FIG. 1A shows an exterior of a digital camera according to the present invention. The front of the digital camera 2 is provided with a lens barrel 4 from which a taking lens 5 held thereby is exposed, a flash unit 7 for emitting flashlight, and a viewfinder window 8 to face a subject. The top of the digital camera 2 is provided with a shutter button 10. Upon depression of the shutter button 10, a recording operation of image data of the subject is started.

FIG. 1B shows the rear of the digital camera 2. An upper portion of the digital camera 2 is provided with a viewfinder eyepiece window 15. The rear of the digital camera 2 is provided with a switch 17 for setting a mode of the digital camera, and an operation member 20 for carrying out zooming and so forth. The switch 17 sets the mode of the digital camera to one of a still-image photographing mode, a replay mode and a moving-image photographing mode. When the still-image photographing mode is set, image data is produced by photographing a subject and is recorded in a recording medium. When the replay mode is set, the image data recorded in the recording medium is displayed on a liquid-crystal panel 13. When the moving-image photographing mode is set, moving images of a few dozen frames are photographed per second. At an under portion of the operation member 20, are arranged a selection/execution button 22 for selecting and executing a menu displayed on the liquid-crystal panel 13, a cancel button 24 for canceling the execution of the menu, and a changeover button 26 for turning on and off the liquid-crystal panel 13.

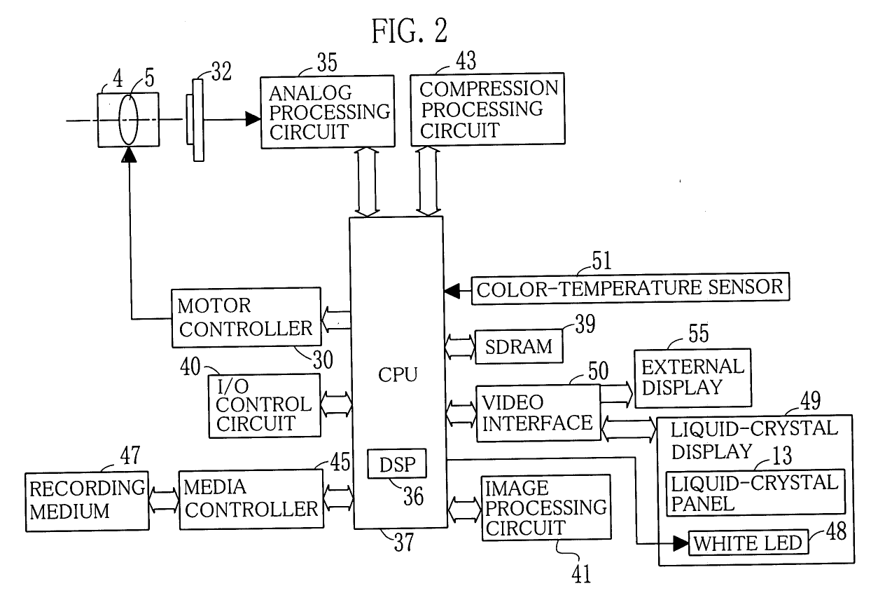

FIG. 2 shows a block diagram of the digital camera. The lens barrel 4 contains a zoom motor for carrying out zooming, and a focus motor for adjusting a focal point. These motors are driven and controlled by a motor controller 30. An image of a subject is formed on a CCD image sensor 32 through the taking lens 5. The subject image formed on the CCD image sensor is photoelectrically converted into an image signal, and then, this image signal is inputted into an analog processing circuit 35.

The analog processing circuit 35 includes a correlation double sampling circuit, an amplification circuit and an A-D conversion circuit. In the correlation double sampling circuit, the image signal is converted into RGB analog signals relative to each cell of the CCD image sensor 32. The RGB analog signals are amplified in the amplification circuit and are digitally converted into image data in the A-D conversion circuit to produce the image data constituted of RGB digital data. This sequential operation is controlled by a CPU 37 including a digital signal processor (hereinafter DSP) 36. The CPU 37 controls the whole operation of the digital camera 2.

Upon depressing the shutter button 10 under the still-image photographing mode, a signal is inputted into the CPU 37 via an I/O control circuit 40, and the image data from the analog processing circuit 35 is stored in an SDRAM 39 in response to an instruction of the CPU 37. The image data stored in the SDRAM 39 is inputted into an image processing circuit 41 wherein various image processes of gamma correction, contour correction and so forth are carried out. The processed image data is temporarily stored in the SDRAM 39.

The image data stored in the SDRAM 39 is inputted into a compression processing circuit 43 and is compressed in a predetermined image-quality mode. The compressed image data is inputted into a media controller 45 and is recorded in a recording medium 47 loaded in the digital camera 2.

The liquid-crystal panel 13 included in a liquid-crystal display 49 is illuminated by using either of outside light and a white LED 48 being as a light source for backlight. When the liquid-crystal panel 13 is turned on under either of the still-image photographing mode and the moving-image photographing mode, white balance of the image data, which is processed in the image processing circuit 41 and is stored in the SDRAM 39, is corrected in the DSP 36 to produce LCD image data. A video interface 50 being as a display controller inputs the LCD image data into the liquid-crystal panel 13. This liquid-crystal panel 13 into which the LCD image data is inputted is illuminated by the white LED 48 to display a through image.

Under an LCD backlight-illumination mode (first illumination mode) wherein the liquid-crystal panel 13 is turned on in the reproduction mode and is illuminated by the white LED 48, the image selected from among the images recorded in the recording medium 47 is read out and is stored in the SDRAM 39. The LCD image data is produced from the image data stored in the SDRAM 39. The LCD image data is inputted into the video interface 50 and is inputted into the liquid-crystal panel 13, which is illuminated by the white LED 48 to display an image.

Under an LCD outside-light-illumination mode (second illumination mode) wherein the liquid-crystal panel 13 is illuminated by the outside light, the image selected from among the images recorded in the recording medium 47 is inputted into the SDRAM 39, and the white balance of the image data is corrected in the DSP 36 on the basis of a color temperature detected by the CPU 37 to produce the LCD image data. The produced LCD image data is inputted into the liquid-crystal panel 13 via the video interface 50 being as a display inputting member. The liquid-crystal panel 13 is illuminated by the outside light.

When the taken image and the through image are displayed on an external display 55, the digital camera 2 is connected to the external display 55 with an exclusive connection cable. Video-output image data produced by the CPU 37 is outputted via the connection cable to display the image on the external display 55.

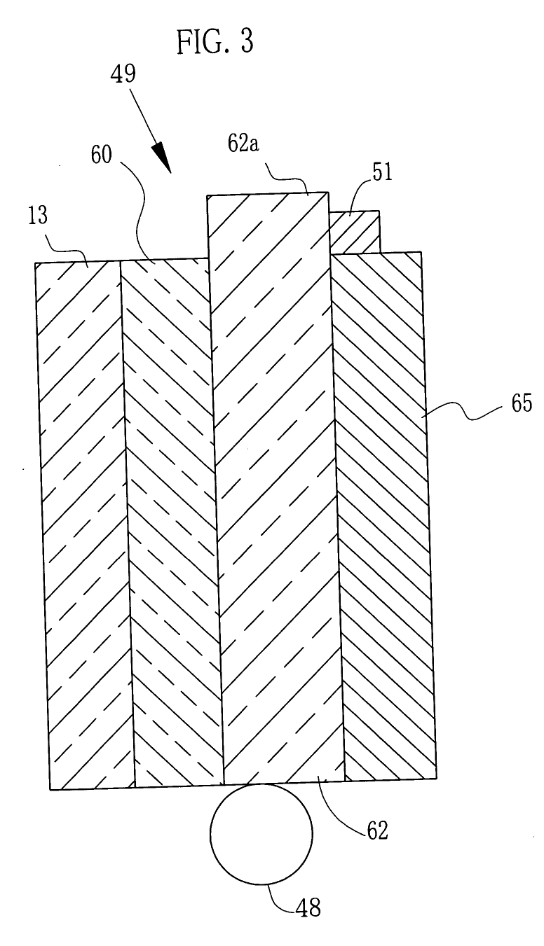

FIG. 3 shows a schematic section view wherein the liquid-crystal display 49 is vertically cut along a plane perpendicular to the liquid-crystal panel 13. The liquid-crystal display 49 comprises the liquid-crystal panel 13 and a semi-transparent reflector plate 60 disposed behind the liquid-crystal panel 13. The liquid-crystal display 49 further comprises a light guide plate 62 and a reflector plate 65, which are disposed behind the semi-transparent reflector plate 60 in order. The top of the light guide plate 62 is formed with a light introducing portion 62a for introducing the outside light. The outside light introduced from the light introducing portion 62a spreads in the light guide plate 62 and passes through the semi-transparent reflector plate 60 to illuminate the liquid-crystal panel 13. An upper portion of the light guide plate 62 is provided with a color-temperature sensor 51 for inputting color-temperature information of the outside light into the CPU 37. The bottom of the light guide plate 62 is provided with the white LED 48 for the backlight. By disposing the color-temperature sensor 51 near the light introducing portion 62a, the CPU 37 can accurately detect the color temperature of the outside light illuminating the liquid-crystal panel 13.

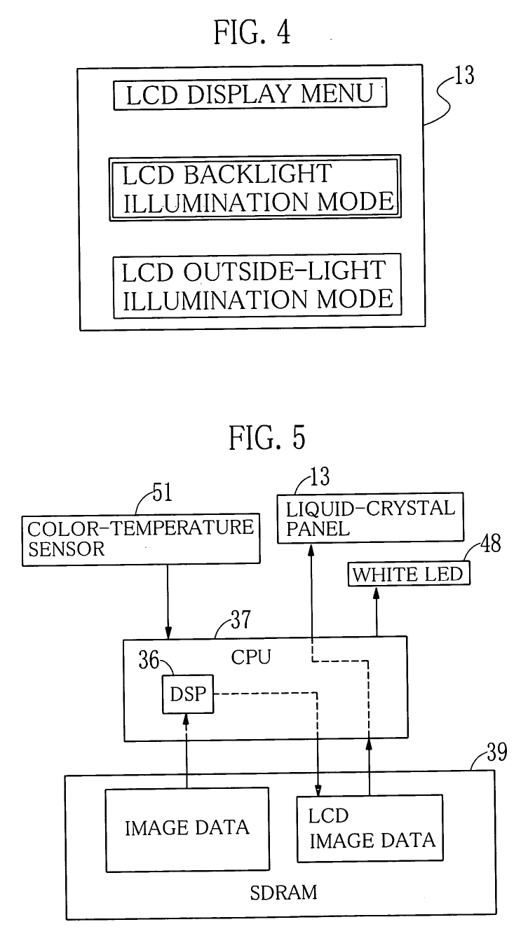

An operation of the digital camera 2 under the replay mode is described below. When the mode switch 17 is slid to set the digital camera 2 in the replay mode, a menu picture shown in FIG. 4 is displayed on the liquid-crystal panel 13. At this time, the digital camera 2 is automatically set in the LCD back light-illumination mode, and the liquid-crystal panel 13 into which the menu picture is inputted is illuminated by the white LED 48. From the menu picture, a user selects the illumination mode to be used, by handling the operation member 20 being as a setting member. The illumination mode to be used is either of the LCD backlight-illumination mode in which the white LED 48 illuminates the liquid-crystal panel 13, and the LCD outside-light-illumination mode in which the outside light illuminates the liquid-crystal panel 13. After the user has handled the operation member 20, an operational signal is inputted into the CPU 37 via the I/O control circuit 40 to set the desired illumination mode.

FIG. 5 is a partial block diagram for explaining an operation of the digital camera 2 under the LCD outside-light-illumination mode. The image selected from among the images recorded in the recording medium 47 is temporarily stored in the SDRAM 39. The color-temperature information of the outside light is inputted into the CPU 37 from the color-temperature sensor 51 so that the color temperature of the outside light is detected. On the basis of the detected color temperature, the DSP 36 changes values of R and B of the image data inputted from the SDRAM 39 to correct the white balance. At this time, a value of G is fixed and the values of R and B are changed. For example, when the detected color temperature of the outside light is low, the R value is decreased and the B value is increased. Meanwhile, when the color temperature is high, the B value is decreased and the R value is increased. After adjusting the R value and the B value and after adjusting a size and so forth as well, the LCD image data is temporarily stored in the SDRAM 39. The LCD image data is inputted into the liquid-crystal panel 13 from the SDRAM 39 via the video interface 50. The liquid-crystal panel 13 into which the LCD image data is inputted is illuminated by the outside light supplied from the light guide plate 62.

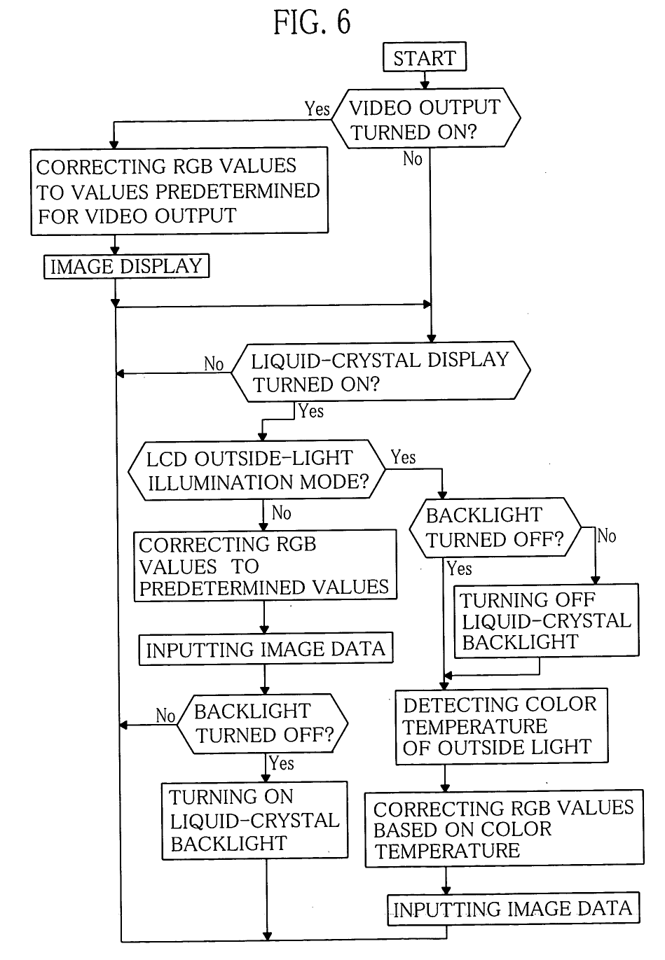

An operation of the digital camera 2 is described below, referring to a flowchart shown in FIG. 6. When the image data is produced by processing the image signal outputted from the CCD image sensor, and when the digital camera is set in either of the still-image photographing mode and the moving-image photographing mode, and further when the liquid-crystal panel 13 is turned on, the through image is displayed on the liquid-crystal panel 13. In the case that the shutter button 10 is depressed under the still-image photographing mode, the image data is recorded in the recording medium 47.

In the case the through image and the image recorded in the recording medium 47 are video-outputted, the values of R, G and B of the image data are set to predetermined values to produce the video-output image data, which is outputted to the external display 55 through the connection cable.

When the LCD outside-light-illumination mode is selected by the user under the replay mode, the color-temperature information of the outside light is inputted into the CPU 37 from the color-temperature sensor 51. On the basis of the color temperature of the outside light detected by the CPU 37, the values of R, G, and B of the image data are adjusted in the DSP 37 to produce the LCD image data. The produced LCD image data is temporarily stored in the SDRAM 39.

The LCD image data is inputted into the liquid-crystal panel 13 from the SDRAM 39 via the video interface 50. The liquid-crystal panel 13 is illuminated by the outside light supplied from the light guide plate 62. The liquid-crystal panel 13 displays the image of which the white balance is corrected on the basis of the color temperature of the outside light.

When the LCD backlight-illumination mode is selected by the user, the values of R, G and B of the image data are set to the predetermined values to produce the LCD image data. The produced LCD image data is inputted into the liquid-crystal panel 13, and the white LED 68 is turned on to illuminate the liquid-crystal panel 13.

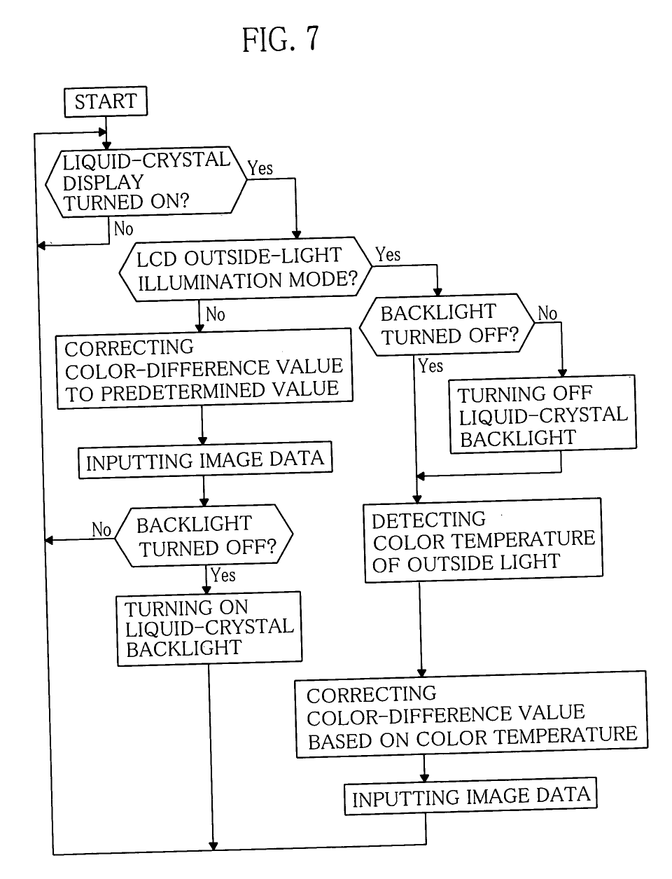

Incidentally, in the above embodiment, the R value and the B value of the image data are adjusted on the basis of the color temperature of the outside light, and the image of which the white balance is corrected is displayed on the liquid-crystal panel 13. However, the liquid-crystal panel may display the image of which a color balance is corrected by adjusting values of color-difference data Cb and Cr. By the way, the image data includes brightness data Y and the color-difference data Cb and Cr. FIG. 7 is a flowchart showing an operation of the digital camera in which the color-difference data is corrected. On the basis of RGB digital data produced from an image signal outputted from the CCD image sensor, a predetermined operation is executed to obtain the brightness data Y. A value of the color-difference data Cb is obtained from the calculated brightness data Y and the R value. A value of the color-difference data Cr is obtained from the brightness data Y and the B value. The image data produced in YCbCr format is recorded in the recording medium via the media controller. When the liquid-crystal panel 13 is turned on and the LCD outside-light-illumination mode is set under the replay mode, the color-difference data Cb and Cr are corrected in the DSP on the basis of the color-temperature information of the outside light detected by the color-temperature sensor 51. And then, the image data to be inputted into the liquid-crystal panel is produced. The image data inputted into the liquid-crystal panel 13 is illuminated by the outside light having passed through the light guide plate to display the image. When the LCD backlight-illumination mode is set, the color-difference data Cb and Cr are set to predetermined values and are inputted into the liquid-crystal panel. And then, the white LED is turned on to illuminate the image data inputted into the liquid-crystal panel 13. When the taken image is reproduced on the external display, the color-difference data Cb and Cr are corrected so as to be predetermined values, and the image data for video output is produced.

In the above embodiment, the CPU 37 includes the DSP 36 by which the RGB values of the image data are corrected every pixel. The image data, however, may be corrected by another method. For example, the image data may be corrected by using a look-up data table (hereinafter, LUT) and a CPU instead of the DSP. For instance, a ROM provided in the digital camera stores in advance the LUT for correcting the image data in accordance with color temperatures of a fluorescent lamp, the sunlight, the evening sun, the morning sun and so forth. The LUT is read out of the ROM in accordance with the color temperature of the detected outside light to correct the image data. In such a system, it is possible to correct the color balance of the image data without using the expensive DSP so that the cost of the digital camera may be reduced.

In the above embodiment, the liquid-crystal panel 13 displays the menu picture for selecting either of the two illumination modes to set it. However, the method for setting the illumination mode is not limited to the above embodiment. For example, the illumination mode may be set by horizontally moving a slide switch, which is movable in a light-and-left direction and is disposed under the liquid-crystal panel, for instance. The slide switch sets the LCD outside-light-illumination mode when moved to one end, and sets the LCD backlight-illumination mode when moved to the other end.

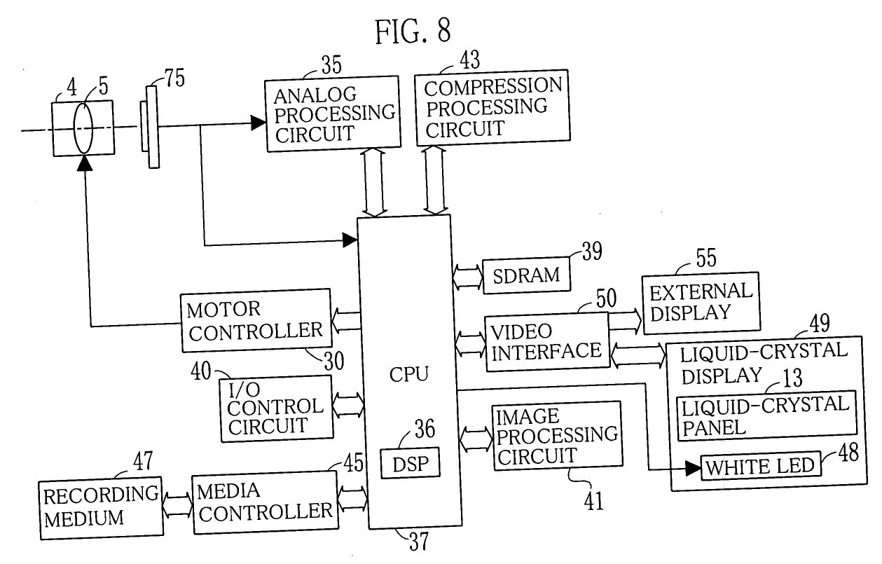

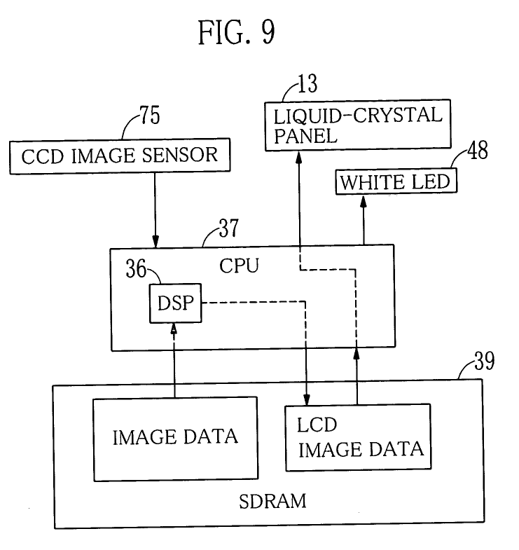

Next, a second embodiment is described below. In the second embodiment, the color temperature of the outside light is detected by utilizing the CCD image sensor for outputting the image signal. FIG. 8 is a block diagram of a digital camera in which the color temperature of the outside light is detected by using an image signal outputted from a CCD image sensor. The color temperature of the outside light is detected by the CPU 37 on the basis of the image signal outputted from the CCD image sensor 75. Under the LCD outside-light-illumination mode, such as shown in FIG. 9 of a partial block diagram, the DSP 36 changes the values of R, G and B of the image data, which is stored in the SDRAM 39, in accordance with the color temperature of the outside light detected by the CPU 37 to produce display image data. This display image data is inputted into the liquid-crystal panel 13 via the vide interface. And then, the liquid-crystal panel 13 is illuminated by the outside light supplied from the light guide plate to display the image. In this way, the color temperature is detected by utilizing the image signal outputted from the CCD image sensor 75 so that a number of parts constituting the digital camera may be reduced.

Incidentally, the above first and second embodiments are described with the digital camera. The present invention, however, is not exclusive to the above embodiments. For example, the present invention may be applicable to a cell phone with a camera provided with a CCD image sensor. In this case, it is possible to provide a camera-fitted cell phone having higher convenience.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A photographing apparatus for producing image data on the basis of an image signal outputted from a CCD image sensor, comprising:
a liquid-crystal panel to be illuminated by one of a backlight and an outer light;
an illumination-mode setting member for setting one of a first illumination mode for illuminating said liquid-crystal panel with said backlight, and a second illumination mode for illuminating said liquid-crystal panel with said outside light;
a color-temperature detector for detecting a color temperature of said outside light; and
a color-balance corrector for correcting color balance of said image data in accordance with the color temperature of said outside light, which is detected by said color-temperature detector, when said second illumination mode is set, the corrected image data being inputted into said liquid-crystal panel.

2. A photographing apparatus according to claim 1, wherein said color-temperature detector detects the color temperature of said outside light on the basis of said image signal outputted from said CCD image sensor.

3. A photographing apparatus according to claim 1, wherein said color-temperature detect or detects the color temperature of said outside light on the basis of color-temperature information outputted from a color-temperature sensor disposed at a position where said outside light enters.

4. A photographing apparatus according to claim 3, wherein a rear side of said liquid-crystal panel is provided with a light guide plate for illuminating said liquid-crystal panel from the rear side.

5. A photographing apparatus according to claim 4, wherein said light guide plate has a light introducing portion formed at one end thereof in order to introduce said outside light, and said color-temperature sensor is disposed near said light introducing portion.

6. A photographing apparatus according to claim 5, wherein a light source for said backlight is disposed near the other end of said light guide plate.

7. A photographing apparatus according to claim 6, wherein said light source is a white LED.

8. A photographing apparatus according to claim 7, wherein said outside light and said backlight illuminate said liquid-crystal panel through a semi-transparent reflector plate disposed between said liquid-crystal panel and said light guide plate.

9. A photographing apparatus according to claim 1, wherein said image data is prevented from being corrected by said color-balance corrector when said first illumination mode is set.

10. A photographing apparatus according to claim 9, wherein said illumination-mode setting member is externally operational.

11. A photographing apparatus according to claim 10, wherein said photographing apparatus is a digital camera, and said illumination-mode setting member is arranged at the rear of said digital camera.
